(19) United States
(12) Patent Application Publication
(10) Pub. No.: US 2010/0271606 A1
(43) Pub. Date: Oct. 28, 2010

(54) LITHOGRAPHIC APPARATUS AND A METHOD OF OPERATING THE APPARATUS

(75) Inventors: Laurens Anthony SANDERSE, Eindhoven (NL); Josephus Cornelius Johannes Antonius Vugts, Goirle (NL); Ivo Adam Johannes Thomas, Son (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/763,846

(22) Filed: Apr. 20, 2010

Related U.S. Application Data
(60) Provisional application No. 61/171,704, filed on Apr. 22, 2009.

(51) Int. Cl. G03B 27/32; G03B 27/42

(52) U.S. Cl. 355/53; 355/77

(57) ABSTRACT

An immersion lithographic apparatus is disclosed. The apparatus has a projection system configured to project a patterned radiation beam onto a target portion of the substrate, the projection system having a lower surface. The apparatus also has a liquid confinement structure defining, in use, in part with the lower surface and the substrate and/or substrate table, an immersion space, the immersion space comprising, in use, a liquid meniscus between a part of the lower surface facing a surface of the liquid confinement structure and a facing surface of the liquid confinement structure facing the part of the lower surface. The apparatus also has a pinning surface comprising a plurality of meniscus pinning features, the pinning surface being part of or on the part of the lower surface, or part of or on the facing surface of the liquid confinement structure, or part of or on both.

This application claims priority and benefit under 35 U.S.C. §119(e) to U.S. Provisional Patent Application No. 61/171,704, entitled “Lithographic Apparatus and a Method of Operating the Apparatus”, filed on Apr. 22, 2009. The content of that application is incorporated herein in its entirety by reference.

### FIELD

The present invention relates to an immersion lithographic apparatus and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate, using a projection system. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example U.S. Pat. No. 4,509,852) means that there is a large body of liquid that should be accelerated during a scanning exposure. This may require additional or more powerful motors and turbulence in the liquid may lead to undesirable and unpredictable effects.

In an immersion apparatus, immersion fluid is handled by a fluid handling system, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

In a proposed arrangement a liquid supply system provides liquid on only a localized area of a surface of a substrate and/or substrate table. The liquid may be confined between the final optical element of the projection system and the surface of the substrate and/or substrate table using a liquid confinement structure. (The substrate generally has a larger surface area than the final element of the projection system).

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

After exposure of a substrate in an immersion lithographic apparatus, the substrate table is moved away from its exposure position to a position in which the substrate may be removed and replaced by a different substrate. This is known as substrate swap. In a two stage lithographic apparatus, the substrate tables swap may take place under the projection system. During, for example, substrate swap, immersion liquid may be retained between the final element and the surface of the substrate and/or substrate table, within the liquid confinement structure. In a multi stage, e.g. dual stage, apparatus the surface may change, for example, from the surface of a table to the surface of a different table, see United States patent application publication no. US 2005-0036121, which is hereby incorporated by reference in its entirety.

PCT patent application publication no. WO 2005/064405 discloses an all wet arrangement in which the immersion liquid is unconfined. In such a system substantially the whole top surface of the substrate is covered in liquid. This may be advantageous because then the whole top surface of the substrate is exposed to the substantially same conditions. This may have an advantage for temperature control and processing of the substrate. In WO 2005/064405, a liquid supply system provides liquid to the gap between the final element of the projection system and the substrate. That liquid is allowed to leak over the remainder of the substrate. As disclosed in US patent application publication no. US 2009-0168042, which is hereby incorporated by reference in its entirety, a gutter and/or a barrier at the edge of a substrate table may prevent the liquid from escaping so that it can be removed from the top surface of the substrate table in a controlled way. Although such a system may improve temperature control and processing of the substrate, evaporation of the immersion liquid can still occur. One way of helping to alleviate that problem is described in United States patent application publication no. US 2006/119809. A member is provided which covers the substrate W in all positions and which is arranged to have immersion liquid extending between it and the top surface of the substrate and/or substrate table which holds the substrate.

In a fluid handling system liquid is confined to a space, for example within or by a liquid confinement structure, and in the case of a localized area immersion system, a liquid meniscus may define the immersion space between the fluid handling system and an underlying surface (e.g. a substrate table, a substrate supported on the substrate table, and/or a shutter member, wherein the shutter member may include the measurement table). In an all wet system, liquid is allowed to flow out of the immersion space onto the top surface of the substrate and/or substrate table; however, the immersion space may be defined between the underlying surface and a fluid handling structure by a restriction, such as shown in United States patent application publication no. US 2010-0060868, which is hereby incorporated by reference in its entirety.

### SUMMARY

Providing an immersion liquid between the projection system and the substrate for the patterned radiation beam to pass through presents particular challenges, For example, a meniscus of immersion liquid may be present between the liquid confinement structure and a lower surface of the projection system. The meniscus may move during operation, for example in response to relative movement in different directions due to different scanning and stepping directions between the projection system and the substrate table. Because of the movement of the meniscus, the position of the meniscus on the lower surface and the facing surface of the liquid confinement structure changes over time. So the area of the lower surface and the surface of the liquid confinement structure that is wetted varies during operation with the movement of the meniscus. A changing wetted surface area may lead to varying evaporation rates over time on, for example, the lower surface. A non uniform thermal load on, for example, the lower surface of the projection system may cause an imaging error, a focusing error, or both, in the projection system.

It is desirable, for example, to provide an immersion lithographic apparatus in which an imaging error and/or focusing error of the projection system which is caused by movement of the meniscus is reduced, if not eliminated.

According to an embodiment, there is provided an immersion lithographic apparatus, comprising: a substrate table configured to hold a substrate; a projection system configured to project a patterned radiation beam onto a target portion of the substrate, the projection system having a lower surface; a liquid confinement structure defining, in use, in part with the lower surface and the substrate and/or substrate table, an immersion space, the immersion space comprising, in use, a liquid meniscus between a part of the lower surface facing a surface of the liquid confinement structure and a facing surface of the liquid confinement structure facing the part of the lower surface; and a pinning surface comprising a plurality of meniscus pinning features, the pinning surface being part of or on the part of the lower surface, or part of or on the facing surface of the liquid confinement structure, or part of or on both.

According to an embodiment, there is provided a method for reducing an evaporational load on a projection system in an immersion lithography apparatus in which a liquid confinement structure is configured to at least partly confine immersion liquid to an immersion space defined by the projection system, the liquid confinement structure and a substrate and/or a substrate table, the method comprising pinning a meniscus of the immersion liquid in the immersion space present between a part of a lower surface of the projection system and a facing surface of the liquid confinement structure facing the part of the lower surface using a meniscus pinning feature of a plurality of meniscus pinning features of a pinning surface, the pinning surface being part of or on the part of the lower surface, or of or on the facing surface of the liquid confinement structure, or of or on both.

According to an embodiment, there is provided an immersion lithographic apparatus, comprising: a substrate table configured to hold a substrate; and a projection system configured to project a patterned radiation beam onto a target portion of the substrate, the projection system having a lower surface; a liquid confinement structure defining, in use, in part with the lower surface and the substrate and/or substrate table, an immersion space, the immersion space comprising, in use, a liquid meniscus between a part of the lower surface facing a surface of the liquid confinement structure and a facing surface of the liquid confinement structure facing the part of the lower surface; and a pinning surface comprising a plurality of meniscus pinning features, the pinning surface being part of or on the part of the lower surface, or part of or on the facing surface of the liquid confinement structure, or part of or on both, the pinning surface being configured to limit, in use, movement of the meniscus over the lower surface.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a fluid handling structure as a liquid supply system for use in a lithographic projection apparatus;

FIG. 4 depicts a further liquid supply system for use in a lithographic projection apparatus;

FIG. 5 depicts, in cross-section, a barrier member which may be used in an embodiment of the present invention as a liquid supply system;

FIG. 6 depicts, in cross-section, a liquid confinement structure and projection system;

FIG. 7 depicts, in cross-section, a further liquid confinement structure and projection system;

FIG. 8 depicts, in cross-section, a liquid confinement structure and projection system according to an embodiment of the invention;

FIG. 9 depicts, in cross-section, a liquid confinement structure and projection system in accordance with a further embodiment of the invention;

FIG. 10 depicts, in cross-section, a liquid confinement structure and projection system in accordance with a further embodiment of the invention;

FIG. 11 depicts, in cross-section, a liquid confinement structure and projection system in accordance with a further embodiment of the invention;

FIG. 12 depicts, in cross-section, a liquid confinement structure and projection system in accordance with a further embodiment of the invention;

FIG. 13 depicts, in cross-section, a liquid confinement structure and projection system in accordance with a further embodiment of the invention; and

FIG. 14 depicts, in cross-section, a liquid confinement structure and projection system in accordance with a further embodiment of the invention.

### DETAILED DESCRIPTION

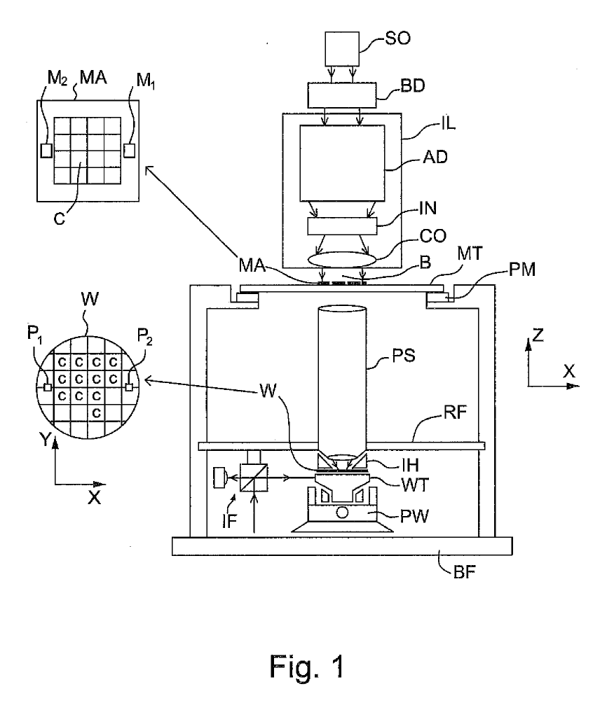

FIG. 1 schematically depicts a lithographic apparatus according to one embodiment of the invention. The apparatus comprises:
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. The support structure MT holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as desired. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. The types of projection system may include: refractive, reflective, catadioptric, magnetic, electromagnetic and electrostatic optical systems, or any combination thereof. The selection or combination of the projection system is as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable minor array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AM for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS. The projection system focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as desired after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In an arrangement a liquid supply system may provide liquid on only a localized area of an underlying surface, which may be a substrate. The liquid may be confined between the final element of the projection system and the underlying surface, such as a substrate (the substrate generally has a larger surface area than the final element of the projection system), using a liquid confinement system.

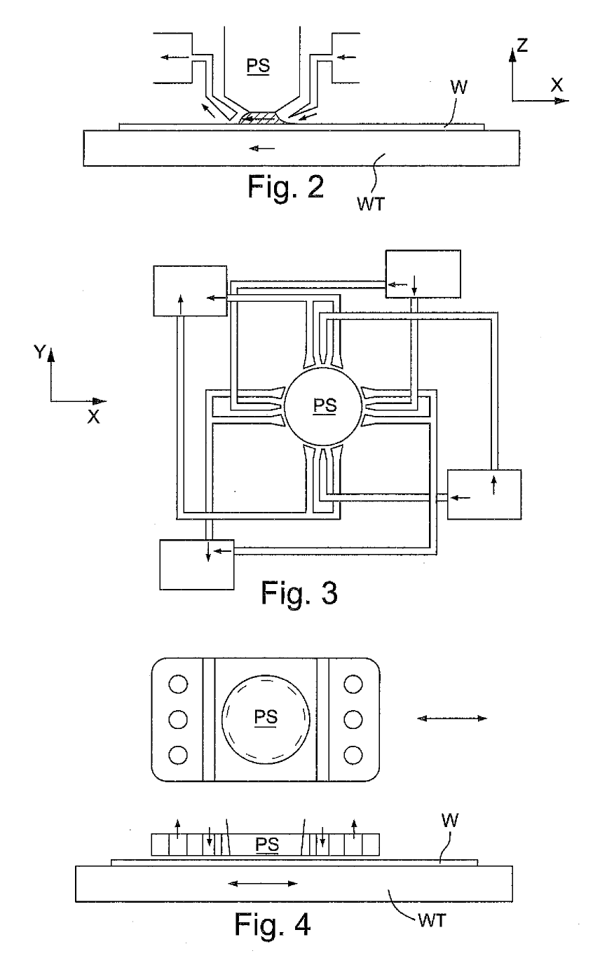

An arrangement to provide liquid between a final element of the projection system PS and the substrate is the so called localized immersion system IH. In this system a liquid handling system is used in which liquid is only provided to a localized area of the substrate. The space filled by liquid is smaller in plan than the top surface of the substrate and the area filled with liquid remains substantially stationary relative to the projection system PS while the substrate W moves underneath that area. Four different types of localized liquid supply systems are illustrated in FIGS. 2-5.

One way which has been proposed to arrange for this is disclosed in PCT patent application publication no. WO 99/49504. As illustrated in FIGS. 2 and 3, liquid is supplied by at least one inlet onto the substrate, preferably along the direction of movement of the substrate relative to the final element, Liquid is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. In the illustration of FIG. 2 the liquid is supplied along the direction of movement of the substrate relative to the final element, though this does not need to be the case. Various orientations and numbers of in- and outlets positioned around the final element are possible; one example is illustrated in FIG. 3 in which four sets of an inlet with an outlet on either side are provided in a regular pattern around the final element. Note that the direction of flow of the liquid is shown by arrows in FIGS. 2 and 3.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and outlets can be arranged in a plate with a hole in its centre and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). Note that the direction of flow of the liquid is shown by arrows in FIG. 4.

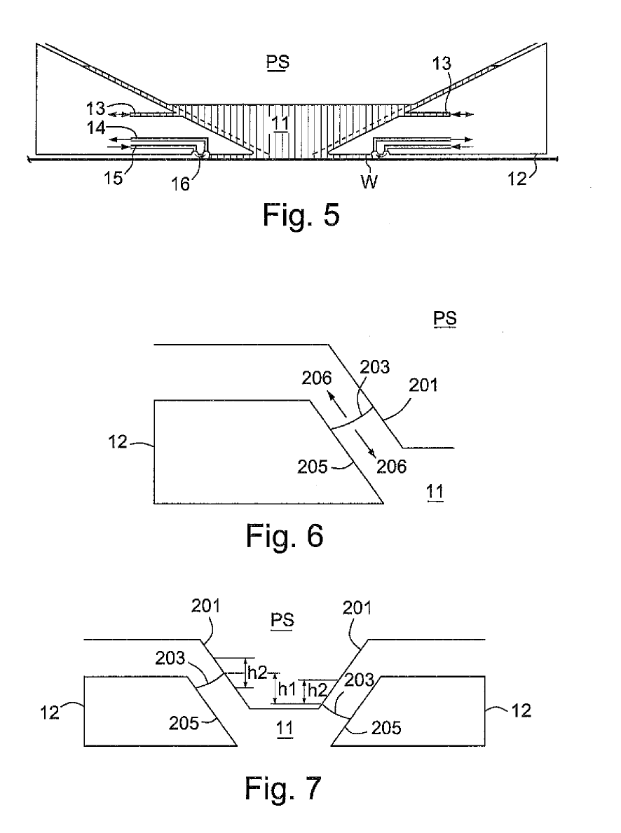

Another arrangement which has been proposed is to provide the liquid supply system with a liquid confinement member which extends along at least a part of a boundary of the space between the final element of the projection system and the substrate table. Such an arrangement is illustrated in FIG. 5. The immersion system has a localized liquid supply system with a liquid confinement structure, which supplies liquid to a limited area of, for example, a substrate. The liquid confinement structure extends along at least part of a boundary of the space between the final element of the projection system and the underlying surface of the substrate, substrate table or both. (Please note that reference in the following text to the surface of the substrate also refers in addition or in the alternative to a surface of the substrate table, unless expressed otherwise). The liquid confinement member is substantially stationary relative to the projection system in the XY plane though there may be some relative movement in the Z direction (in the direction of the optical axis). In an embodiment a seal is formed between the liquid confinement structure 12 and the surface of the substrate W. The seal may be a contactless seal such as a fluid seal such as a gas seal or a capillary force seal. Such a system is disclosed in United States patent application publication no. US 2004-0207824, hereby incorporated in its entirety by reference.

The liquid confinement structure 12 at least partly contains liquid in the immersion space 11 between a final element of the projection system PS and the substrate W. A contactless seal 16 to the substrate W may be formed around the image field of the projection system so that liquid is confined within the space between the substrate W surface and the final element of the projection system PS. The immersion space is at least partly formed by the liquid confinement structure 12 positioned below and surrounding the final element of the projection system PS. Liquid is brought into the space below the projection system and within the liquid confinement structure 12 by liquid inlet 13. The liquid may be removed by liquid outlet 13. The liquid confinement structure 12 may extend a little above the final element of the projection system. The liquid level rises above the final element so that a buffer of liquid is provided. In an embodiment, the liquid confinement structure 12 has an inner periphery that at the upper end closely conforms to the shape of the projection system or the final element thereof and may, e.g., be round. At the bottom, the inner periphery closely conforms to the shape of the image field, e.g., rectangular, though this need not be the case.

In an embodiment, the liquid is contained in the immersion space 11 by a gas seal 16 which, during use, is formed between the bottom of the barrier member 12 and the surface of the substrate W. Other types of seal, such as a seal dependent on capillary forces and meniscus pinning, are possible, as is no seal (for example in an all wet embodiment). The gas seal is formed by gas, e.g. air or synthetic air but, in an embodiment, N₂ or another inert gas. The gas in the gas seal is provided under pressure via inlet 15 to the gap between liquid confinement structure 12 and substrate W. The gas is extracted via outlet 14. The overpressure on the gas inlet 15, vacuum level on the outlet 14 and geometry of the gap are arranged so that there is a high-velocity gas flow 16 inwardly that confines the liquid. The force of the gas on the liquid between the liquid confinement structure 12 and the substrate W contains the liquid in an immersion space 11. The inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824.

Other arrangements are possible and, as will be clear from the description below, an embodiment of the present invention may use any type of localized liquid supply system as the liquid supply system. Such a localized liquid supply system seals between a part of the liquid confinement structure and a substrate W. The seal may be defined by a meniscus of liquid between the part of the liquid supply system and the substrate W.

Providing an immersion liquid between the projection system and the substrate for the patterned radiation beam to pass through presents particular challenges. For example, a meniscus of immersion liquid may be present between the liquid confinement structure and a lower surface of the projection system. A problem is that the meniscus may move during operation, for example in response to relative movement in different directions due to different scanning and stepping directions between the projection system and the substrate table. Because of the movement of the meniscus, the area of the lower surface and the surface of the liquid confinement structure that is wetted varies during operation. With movement of the liquid meniscus, the wetted surface area increases and/or decreases. A changing wetted surface area may cause varying evaporation rates, for example, within the space between the liquid confinement structure and the lower surface. The consequential evaporation on a surface defining the space applies a heat load to the surface. Varying the area of the surface on which evaporation occurs results in a varying thermal load applied, for example to the lower surface. Such a non uniform thermal load on, for example, the lower surface of the projection system may cause an imaging error, a focusing error, or both, in the projection system.

FIG. 6 illustrates movement of a meniscus. A meniscus of immersion liquid 203 may be present between a lower surface 201 of the projection system PS and a facing surface 205 of the liquid confinement structure 12 facing part of the lower surface 201. Directions of movement of the meniscus 203 during operation are represented by arrows 206 in FIG. 6.

Providing the part of the lower surface 201 facing the surface 205 of the liquid confinement structure, or the surface 205 of the liquid confinement structure facing the part of the lower surface 201, or both, with a plurality of meniscus pinning features is desirable so as to reduce, if not eliminate, an imaging error or focusing error of the projection system caused by movement of the meniscus.

The aforementioned arrangement is desirable as will be explained with reference to FIG. 7. A meniscus 203 is present between the lower surface 201 of the projection system and a facing surface 205 of the liquid confinement structure 12 facing a part of the lower surface 201. The position of the meniscus 203 on, for example, a periphery of the lower surface 201 of the projection system PS may change with time. This may occur during operation, for example, on changing the direction and/or magnitude of relative movement between the projection system PS and the surface of a substrate W and/or substrate table WT. The position of the meniscus may vary because of vibrations within the immersion system. Such vibrations may exhibit themselves as oscillatory movements of the meniscus.

In a cross-sectional view of the immersion system as shown in FIG. 7, a left meniscus and a right meniscus are illustrated. (The terms left and right are only for ease of reference to the drawing.) In an embodiment, the cross-section may be along the direction of relative movement between the projection system and the surface of a substrate and/or substrate table, and the left meniscus may be situated on the trailing side of the liquid confinement structure on the direction of relative motion. The right meniscus may be situated towards the leading side of the liquid confinement structure.

A height difference between similar points of the left and right meniscus is represented by h1. This may be referred to as the meniscus height difference. As mentioned, during operation the meniscus moves, for example due to vibrations such as oscillations within the immersion system. Both the left and the right meniscus as illustrated in FIG. 9 may move during operation. Height variations of the left and right meniscus are illustrated as h2. The height variation of the left meniscus may not be the same as the height variation of the right meniscus. For example the amplitude of the height variation may differ, or the variation in the height of the left and right meniscus may change over time, etc. As will be understood, there may not be a single meniscus height position, nor at a certain time instant, nor over time.

By providing the part of the lower surface facing the surface of the liquid confinement structure, or the surface of the liquid confinement structure facing the part of the lower surface, or both, with a plurality of meniscus pinning features, the movement of the meniscus is reduced. A plurality of meniscus pinning features is used, for example, as there may not be a single meniscus height position around the periphery of the lower surface, for example as represented by a left and a right meniscus in FIG. 7. There may be differences between the immersion lithographic apparatuses of the same type resulting in a different height position of the meniscus within each of these apparatuses. Within one apparatus, a changed operating condition of the apparatus may alter the height position of the meniscus. For example in having the liquid confinement structure displaced at different distances away from the lower surface, such as when lowering or raising the liquid confinement structure, or operating at different relative speeds (scanning speeds), the position of the meniscus may change.

A single pinning feature could be used to secure the meniscus. However it may not be possible to pin securely, for example, the left meniscus to a single pinning feature. A single meniscus pinning feature may limit the movement of the meniscus if the meniscus was in contact with the lower surface near the pinning feature. Such a pinning feature could help to limit the height variations as compared to a situation where there was no meniscus pinning feature. However height variations larger than a certain size, or threshold size, might cause the meniscus to break away from the pinning feature. To help limit or keep control of the movement of the meniscus an additional pinning feature is located close, for example adjacent, to the first pinning feature. The additional pinning feature is spaced away from the first pinning feature but in a location where it is capable of pinning the meniscus.

A further pinning feature may be provided that is located in the region of the meniscus and spaced away from the above-described two meniscus pinning features. Yet more pinning features could be located in the surface region which may be contacted by the meniscus during operation. The pinning features of the pinning surface are spaced apart from each other. So multiple pinning features help cope with one or more of these variations in meniscus position and an associated problem.

By providing the part of the lower surface facing the surface of the liquid confinement structure, or the surface of the liquid confinement structure facing the part of the lower surface, or both, with a plurality of meniscus pinning features, one or more of the above-mentioned problems may be alleviated.

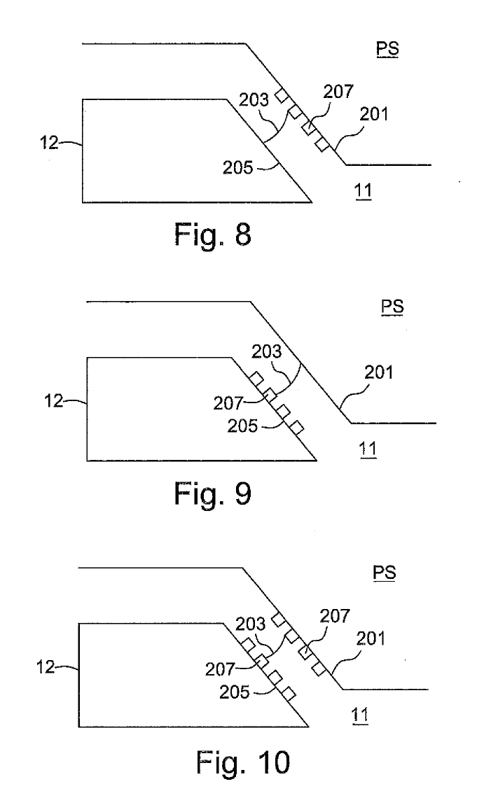

An embodiment of the invention is illustrated in FIG. 8. A meniscus 203 is present between the surface 205 of the liquid confinement structure 12 facing part of the lower surface 201 (herein referred to as the “LCS facing surface”) and the part of the lower surface 201 of the projection system PS facing part of the surface 205 of the liquid confinement structure (herein referred to as the “PS lower surface”). The PS lower surface 201 comprises the plurality of meniscus pinning features 207. The meniscus pinning features 207 of the PS lower surface 201 may reduce the movement of the meniscus 203 over the surface of the PS lower surface 201. Over time, the meniscus might move from a particular pinning feature to another pinning feature, e.g. due to a change in the machine operating conditions. Further, due to the presence of the plurality of meniscus pinning features, the movement of the meniscus 203 over the LCS facing surface 205 may be reduced. Thus the non uniform thermal load as a consequence of evaporation of liquid on the LCS facing surface may reduce.

In FIG. 9 a further embodiment of the invention is illustrated. The LCS facing surface 205 comprises the meniscus pinning features 207 to pin the meniscus 203. The meniscus pinning features 207 of the LCS facing surface 205 may reduce the movement of the meniscus 203 over the surface of the LCS facing surface 205. As the meniscus pinning features 207 are actually comprised in the LCS facing surface 205, the movement of the meniscus 203 at the side of the LCS facing surface 205 may be reduced as compared to the meniscus movement that may occur during operation of the embodiment as described with reference to FIG. 8. Reduction on the meniscus movement over the LCS facing surface 205 may reduce the non uniform thermal load on the LCS facing surface. Further, the meniscus pinning features 207 of the LCS facing surface 205 may reduce the movement of the meniscus 203 over the PS lower surface 201. This embodiment may thus reduce the non uniform thermal load on the PS lower surface 201.

A further embodiment of the invention is illustrated in FIG. 10. Both the LCS facing surface 205 as the PS lower surface 201 comprise a plurality of meniscus pinning features 207. An advantage of this embodiment may be due to the presence of the meniscus pinning features 207 on both surfaces. Advantages associated with the embodiments illustrated in FIGS. 8 and 9 may be achieved in combination. There may be a synergetic effect in having the plurality of meniscus pinning features on both surfaces. There may be a greater reduction in movement of the meniscus 203 on the PS lower surface 201 by having multiple pinning features on the PS lower surface 201 and the LCS facing surface 205 than that achieved by having the multiple pinning features on only one of the surfaces 201, 205, as shown in FIG. 8 or 9. A synergetic effect may be an improved reduction of movement of the meniscus 203 on both surfaces 201, 205. The reason for the improved reduction in movement may be as a consequence of an increased stability of the meniscus, So a reduced movement of the meniscus over one of the surfaces 201, 205 may reduce the movement of the meniscus over the other surface and vice versa. There may be a feedback effect, so that the reduction of movement of the meniscus over one surface 201, 205 may reduce the movement over the facing surface which would help to restrict movement of the meniscus over the first surface and so on. The surfaces may in this context be functionally complementary,

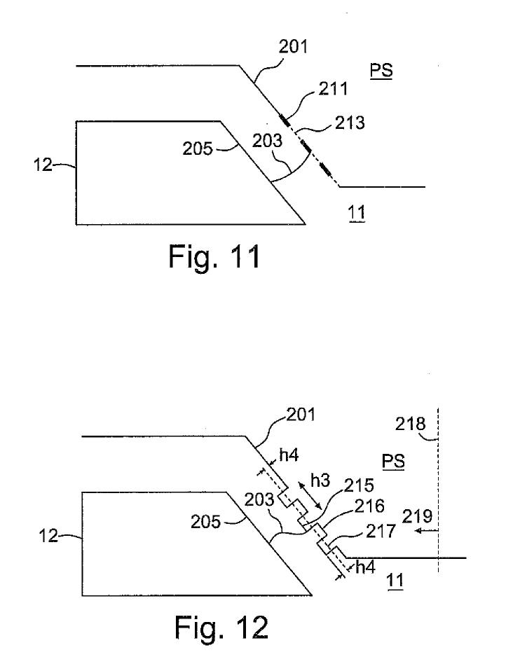

A further embodiment of the invention is illustrated in FIG. 11. The plurality of meniscus pinning features 207 comprised in the PS lower surface 201 comprises a first surface 211 and a second surface 213. Although not illustrated in FIG. 11, the plurality of meniscus pinning features 207 comprising a first surface 211 and a second surface 213 might be comprised in the LCS facing surface 205 instead or in addition to the PS lower surface 201. An advantage associated with the placement of the meniscus pinning features was explained above.

In an embodiment, the contact angle of the first surface 211 and the second surface 213 is different. The point of transition from the first surface 211 to the second surface 213 creates a meniscus pinning feature. (Note that the reference to a point of transition is for ease of reference with respect to FIG. 11. The point on a surface is a line of transition between different surface regions each of which has a different surface property.). The meniscus may not necessarily be pinned to the point of transition between the first and the second surface, but in addition or in alternatively, may be pinned to a surface region having the property of the first surface 211 between two surface regions having the surface property of the second surface 213. For example the surface region having the property of the first surface has opposing sides with adjoining surface regions having a surface property of the second surface 213. For example, the meniscus 203 might be pinned on the surface with the smaller contact angle as the adjacent surfaces with the bigger contact angle more or less prevent the meniscus from entering these adjacent surfaces, effectively pinning the meniscus 203.

The contact angles of the surfaces may be defined statically, as a static contact angle, or dynamically as a receding or advancing contact angle. The difference in surface properties of the two surfaces may be achieved by having the two surfaces comprising different materials and/or having different roughnesses. One of the surfaces properties may be achieved by a coating. In an embodiment, the two surface properties may be achieved by two different coatings. The first surface property might be lyophilic. The second surface might be lyophobic. It might be possible for both surfaces to be lyophilic or lyophobic in which case there is a difference in contact angles between the different surfaces. The difference in receding contact angle between the different surfaces may be larger than 55 degrees, desirably larger than 60 degrees, more desirably larger than 65 degrees. The difference may also be larger than 70, 80, 90, 100, or 110 degrees. Alternatively or additionally, the difference in advancing contact angle between the different surfaces may be larger than 65 degrees. Alternatively or additionally, the difference in static contact angle between the different surfaces may be larger than 65 degrees. The first surface might comprise silicon. The second surface might comprise Teflon.

In an embodiment, the first surface 211 alternates with the second surface 213 in a direction away from an optical axis of the projection system. For example, the first surface 211 might alternate with the second surface 213 as is schematically illustrated in FIG. 11. The first surface 211 may alternate with the second surface in another direction and additionally or alternatively have a changing direction over the PS lower surface 201. In an embodiment there may be a surface with a third surface property or a greater number of surface properties. The different surfaces properties may repeat in a series. In an embodiment, the transition point may be a transition region in which the surface properties gradually change between the different surfaces.

An advantage of the embodiment illustrated in FIG. 11 and its variations is that the movement of the meniscus 203 in the directions as represented by the arrows 206 as illustrated in FIG. 6 is reduced. This may be the case as the meniscus 203 is pinned between meniscus pinning features arranged in the direction of the arrows 206. Other ways of alternation of the first and second surfaces are possible, for example a hatched arrangement. In a configuration, the meniscus 203 may be pinned, in addition or alternatively to the direction of the arrows 206, in a direction around the periphery of the lower surface 201. In a further configuration the meniscus pinning features form a two dimensional array over the surface over which the meniscus moves, for example the meniscus pinning features may have a hatched appearance and/or the appearance of a grid.

A further embodiment of the invention is illustrated in FIG. 12. The meniscus 203 is present between the LCS facing surface 205 and the PS lower surface 201. The PS lower surface 201 comprises the plurality of meniscus pinning features (a multiple pinning surface), wherein the plurality of meniscus pinning features comprise a plurality of protrusions 215. As stated above, among others with reference to FIG. 9 and FIG. 10, the plurality of protrusions may alternately or in addition be present on the LCS facing surface 205. As the meniscus 203 may pin to a protrusion, for example a point of the protrusion, the movement of this meniscus is limited. The reason and benefits for having a plurality of meniscus pinning features 207, in this particular case a plurality of protrusions 215, was discussed above. The benefits discussed above with reference to FIGS. 9-11 may hold for the embodiment illustrated in FIG. 12.

The plurality of protrusions 215 may comprise a plurality of steps or a plurality of grooves. A combination of steps and grooves is possible. The steps and/or grooves may have various shapes, such as rectangle, square, circle, ellipse, oval, triangle, hook, curve, etc. A groove may be defined as a long narrow channel or furrow. A step may be defined as an offset or change in the level of a surface (e.g. similar to the step of a stair). In an embodiment a surface of the step may be substantially planar.

The plurality of protrusions 215 may be substantially randomly organized in a direction away from an optical axis of the projection system. For example, the plurality of protrusions 215 present in the PS lower surface 201 may be more or less randomly located steps 215 on the surface. Alternatively or additionally, the PS lower surface 201 may have a surface with randomly located recesses 216. The steps may alternate with the recesses. At or near the step or recess (e.g., between a step and a recess), there may be an edge or a point to which the meniscus 203 may be pinned. The recess may take the form of irregularly positioned scratches formed in the PS lower surface 201. In an embodiment the plurality of recesses appear randomly located, but this is intentional. In an embodiment, the substantially randomly organized plurality of recesses may have the appearance of the pattern on a tiger or zebra skin. The main direction of each of the plurality of recesses may be in a direction of the periphery of the PS lower surface 201. The recesses may be generally aligned around the optical axis, for example in a direction perpendicular to a radial direction away from the optical axis. The radial direction may correspond to an arrow 219 shown in FIG. 12, which is directed away from an optical axis 218. The main direction may alternatively or in addition be in the direction of the arrows as illustrated in FIG. 6, or in any other direction.

As illustrated in FIG. 12, the surface of each of the plurality of steps 215 and/or recesses 216 may have a certain displacement h4 from a mean contour 217. The mean contour 217 of the multiple pinning surfaces may be defined as the average displacement of each part of the multiple pinning surface relative to a reference surface. The reference surface may be the region of the PS lower surface on which the multiple pinning surface is located. In an embodiment, the reference surface may be defined by the surface of the deepest recess of the multiple pinning surface. In an embodiment, the reference feature may be the highest step or some other reference feature of the multiple pinning surface or of the PS lower surface 201. The range of displacement may be between 1 nm and 1 cm, desirably between 1 and 1000 μm, more desirably between 50 and 200 even more desirably between 75 and 150 μm, or 100 μm. The displacement may or may not be substantially identical for each of the plurality of protrusions, but the displacement of the surface of each protrusion relative to the mean contour may be similar. An advantage of having a relatively small displacement, for example between 1 and 1000 μm, desirably 50 and 200 μm, is that it facilitates implementation in a limited space. A desirable displacement for pinning the meniscus 203 may depend on the system at hand.

As is illustrated in FIG. 12, the protrusions might alternate in a direction away from an optical axis of the projection system. Possible variations in the arrangement of the pinning features over the pinning surface, and their associated benefits, may include those variations already described above with reference to the embodiment illustrated in FIG. 11.

The pitch h3 may be defined between similar features of the multiple pinning features, for example between the similar features of the protrusions (the peak or radial outward or inward edge), as for example illustrated in FIG. 12, and between first and second surfaces (such as alternate transition points), as for example illustrated in FIG. 11. The pitch may be smaller than 5 cm, 1 cm, 5 mm, 3 mm, 1 mm, 500 μm, 100 μm, or 10 μm. The pitch may be larger than 1 nm, 1 μm, 5 μm, 10 μm, 100 μm, 500 μm, 1 mm, 3 mm, or 5 mm. For example, the pitch of the alteration may be between 1 and 3 mm.

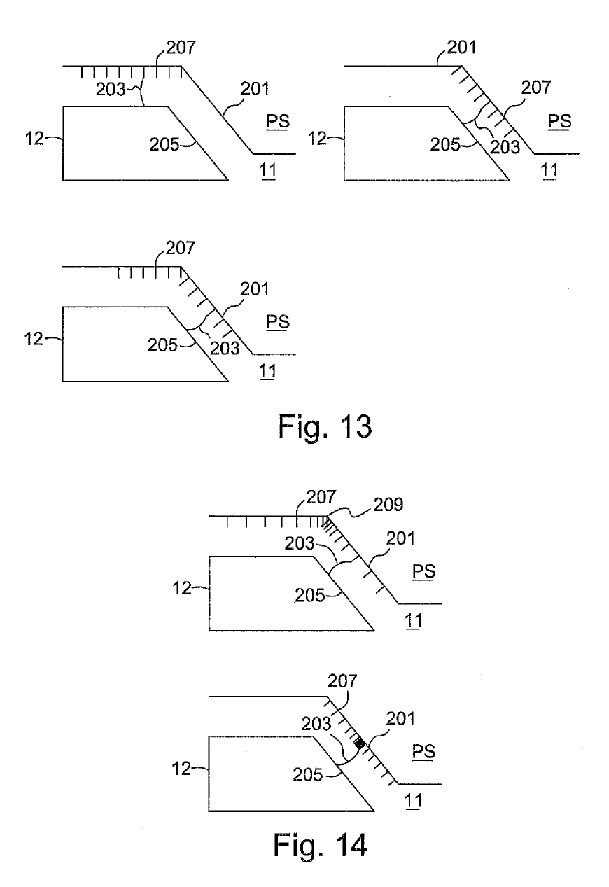

As illustrated in FIG. 13, the plurality of meniscus pinning features 207 may be positioned at various locations. The plurality of meniscus pinning features 207 may be present on any part of the PS lower surface which may contact the meniscus 207. Such a surface may face the liquid confinement structure 12. The PS lower surface 201 may include a radially inward part of the PS lower surface 201, a radially outward part of the PS lower surface 201, or both. The PS lower surface 201 may include the substantially horizontal part of the PS lower surface 201, the part of the PS lower surface 201 which may be sloped towards the optical axis, or both. Analogously, the plurality of meniscus pinning features 207 may alternatively or in addition be present on the LCS facing surface 205.

As mentioned above with reference to FIG. 11, the first surface 211 might alternate with the second surface 213. As mentioned above with reference to FIG. 12, the protrusions might alternate. In an embodiment the surface may have a meniscus pinning feature combining the features of the embodiments shown in FIGS. 11 and 12. The surface may have protrusions and surfaces with different surface properties. As is illustrated in FIG. 14, in an embodiment of the invention, the pitch between alternate features (for example in contact angle properties or in relative displacement) may vary over the multiple pinning surface. For example, the pitch might decrease in a direction away from the radial edges defining the multiple pinning surface. The pitch between the pinning features may increase toward the edges. In an embodiment, the pitch may decrease towards a center of the multiple pinning surface. Alternatively or in addition, the pitch might increase over at least a portion of the multiple pinning features away from the edges of the multiple pinning surface region. The pitch between adjacent multiple pinning features may be smallest in the region of the PS lower surface 201 where the surface changes angle relative to the optical axis or plane perpendicular to the optical axis or a surface of a substrate when in position under the projection system PS, for example at a point 209, In another embodiment the pitch may be largest at or towards the point 209, Varying the pitch in this way enables greater control at the location where the meniscus is most likely to be during use or at a position where the meniscus may be expected to have increased instability. It will be appreciated that other possible positions for the pinning features and pitches between adjacent pinning features may exist. The features described with reference to FIG. 14 refer to the PS lower surface 201. The features analogously apply alternatively or additionally to a multiple pinning surface present on the LCS facing surface 205.

In an embodiment, the plurality of meniscus pinning features are present substantially around the complete periphery of at least part of the lower surface 201 facing the surface of the liquid confinement structure or the surface 205 of at least part of the liquid confinement structure 12 facing the part of the lower surface 201, or both.

In an embodiment, the part of the PS lower surface 201, the LCS facing surface 205, or both, comprises a removable component comprising a multiple pinning surface. An advantage of having a removable component is that the component may be replaced, for example by a completely new, e.g., unused or cleaned, removable component. This may be advantageous in case there is contamination buildup on the removable component which may deteriorate the effectiveness of the pinning of the meniscus. The removable component may be an adhesive sheet, like a sticker. During operation a removable component may be held in place using capillary forces. The removable component may substantially be made of a metal, like stainless steel or titanium, or quartz, or a synthetic material, for example plastic. The removable component may comprise a material to realize the first surface 211 and second surface 213 as illustrated in FIG. 11.

According to an embodiment, one or more of the plurality of meniscus pinning features comprises a fiber in the form of a spring, or a helix. The fiber may be a glass fiber or a wire. The body or a feature of the body of the fiber defines the multiple pinning features. The fiber may surround the optical axis one or more times. Each path around the optical axis may define a separate pinning feature. The fiber may have a different surface property to the surface on to which it is applied. The fiber may be applied onto a removable component which may be shaped to fit the part of the LCS facing surface 205 or the PS lower surface 201 to which it is intended to be applied.

It may be possible to combine features of one or more of the embodiments. For example, any of the features of the embodiment of FIG. 11 may be combined with any features of the embodiment of FIG. 12. Any of the features of the embodiment of FIG. 11 may be combined with any of the features of the embodiments of FIGS. 13 and 14. Any of the features of the embodiment of FIG. 12 may be combined with any of the features of the embodiments of FIGS. 13 and 14. Any of the features of the embodiment of FIG. 11 may be combined with any of the features of the embodiments of FIG. 8, 9 or 10. Any of the features of the embodiment of FIG. 12 may be combined with any of the features of the embodiments of FIG. 8, 9 or 10.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative application's, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components,

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

Controllers described herein may have any suitable configuration for receiving, processing, and sending signals. For example, each controller may include one or more processors for executing the computer programs that include machine-readable instructions for the methods described above. The controllers may include data storage medium for storing such computer programs, and/or hardware to receive such medium.

It will be appreciated that the above description makes reference to a material being lyophobic or lyophilic. This is relevant to any immersion liquid. In the case where the immersion liquid used is water the appropriate terms are hydrophilic and hydrophobic respectively, However, another liquid or fluid may be used as the immersion liquid. In this case the terms hydrophobic and hydrophilic should be read as being liquidphobic or liquidphilic or lipophobic or lipophilic. Liquidphobic (for example, hydrophobic in the presence of water) means a static contact angle of greater than 90°, desirably greater than 100, 120, 130 or 140°. The contact angle in one embodiment is less than 180°, Liquidphilic (for example hydrophilic in the presence of water) means a static contact angle of less than 90°, desirably less than 80°, less than 70°, less than 60° or less than 50°. In one embodiment the contact angle is more than 0°, desirably more than 10°. In a dynamic system, liquidphilic means a receding contact angle of less than 60°, desirably less than 80°, less than 70°, or less than 60° or less than 50° and liquidphobic means more than 60°, desirably greater than 70°, 80°, 90° or 100°. These angles may be measured at room temperature (20° C.) and atmospheric pressure.

One or more embodiments of the invention may be applied to any immersion lithography apparatus, in particular, but not exclusively, those types mentioned above, whether the immersion liquid is provided in the form of a bath, only on a localized surface area of the substrate, or is unconfined on the substrate and/or substrate table. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

In an embodiment, there is provided an immersion lithographic apparatus comprising a substrate table, a projection system and a liquid confinement system. The substrate table is configured to hold a substrate. The projection system is configured to project a patterned radiation beam onto a target portion of the substrate and the projection system has a lower surface. The liquid confinement structure defines, in use, in part with the lower surface and the substrate and/or substrate table, an immersion space. The immersion space comprises, in use, a liquid meniscus between a part of the lower surface facing a surface of the liquid confinement structure and a facing surface of the liquid confinement structure facing the part of the lower surface. The lithographic apparatus further comprises a pinning surface comprising a plurality of meniscus pinning features. The pinning surface is part of or on the part of the lower surface, or part of or on the facing surface of the liquid confinement structure, or part of or on both.

The plurality of meniscus pinning features may comprise more than one type of pinning feature which repeat in series over the pinning surface.

One type of pinning feature may comprise a first surface and a further type of pinning feature may comprise a second surface with a different surface contact angle than the first surface. The contact angle may be defined as a static contact angle or a receding contact angle. The first surface and/or the second surface may be the surface of a coating. The first surface may be lyophilic and the second surface may be lyophobic.

The pinning features may comprise protrusions. At least some of the plurality of protrusions may define a plurality of steps. At least some of the plurality of protrusions may comprise a plurality of recesses. The protrusions may be substantially randomly located along a direction away from an optical axis of the projection system. A surface of each of the protrusions may have a displacement of between 1 and 1000 μm from a mean contour. The mean contour may be the average displacement of the protrusion relative to a reference surface. The displacement may be between 50 and 200 μm.

The series of pinning features may repeat in a direction away from an optical axis of the projection system. A pitch may be defined between adjacent pinning features and the pitch may be smaller than 5 mm. The pitch may be between 1 and 3 mm.

At least one of the pinning features may comprise a fiber. The fiber may define a spring or a helix and may comprise a glass fiber, or a wire.

The plurality of pinning features may be present substantially around the complete periphery of the part of the lower surface, or the facing surface of the liquid confinement structure, or both.

The liquid confinement structure or the projection system may comprise a removable component comprising the pinning surface. The removable component may be an adhesive sheet. The removable component may comprise metal.

In an embodiment there is provided a method for reducing an evaporational toad on a projection system in an immersion lithography apparatus. Herein a liquid confinement structure is configured to at least partly confine immersion liquid to an immersion space defined by the projection system, the liquid confinement structure and a substrate and/or a substrate table. The method may comprises pinning a meniscus of the immersion liquid in the immersion space present between a part of a lower surface of the projection system and a facing surface of the liquid confinement structure facing the part of the lower surface using a meniscus pinning feature of a plurality of meniscus pinning features of a pinning surface. The pinning surface may be part of or on the part of the lower surface, or of or on the facing surface of the liquid confinement structure, or of or on both.

In an embodiment there is provided an immersion lithographic apparatus comprising a substrate table, a projection system and a liquid confinement system. The substrate table is configured to hold a substrate. The projection system is configured to project a patterned radiation beam onto a target portion of the substrate and the projection system has a lower surface. The liquid confinement structure defines, in use, in part with the lower surface and the substrate and/or substrate table, an immersion space. The immersion space comprises, in use, a liquid meniscus between a part of the lower surface facing a surface of the liquid confinement structure and a facing surface of the liquid confinement structure facing the part of the lower surface. The immersion lithographic apparatus further comprises a pinning surface comprising a plurality of meniscus pinning features. The pinning surface is part of or on the part of the lower surface, or part of or on the facing surface of the liquid confinement structure, or part of or on both. The pinning surface may be configured to limit, in use, movement of the meniscus over the lower surface.

Moreover, although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, it will be readily apparent to those of skill in the art based upon this disclosure, For example, it is contemplated that various combination or sub-combinations of the specific features and aspects of the embodiments may he made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

The descriptions above are intended to be illustrative, not limiting. Thus, it will be apparent to one skilled in the art that modifications may be made to the invention as described without departing from the scope of the claims set out below.

What is claimed is:

1. An immersion lithographic apparatus, comprising:
a substrate table configured to hold a substrate;
a projection system configured to project a patterned radiation beam onto a target portion of the substrate, the projection system having a lower surface;
a liquid confinement structure defining, in use, in part with the lower surface and the substrate and/or substrate table, an immersion space, the immersion space comprising, in use, a liquid meniscus between a part of the lower surface facing a surface of the liquid confinement structure and a facing surface of the liquid confinement structure facing the part of the lower surface; and
a pinning surface comprising a plurality of meniscus pinning features, the pinning surface being part of or on the part of the lower surface, or part of or on the facing surface of the liquid confinement structure, or part of or on both.

2. The immersion lithographic apparatus of claim 1, wherein the plurality of meniscus pinning features comprises more than one type of pinning feature which repeat in series over the pinning surface.

3. The immersion lithographic apparatus of claim 2, wherein one type of pinning feature comprises a first surface and a further type of pinning feature comprises a second surface with a different surface contact angle than the first surface.

4. The immersion lithographic apparatus of claim 3, wherein the contact angle is defined as a static contact angle or a receding contact angle.

5. The immersion lithographic apparatus of claim 3, wherein the first surface and/or the second surface is the surface of a coating.

6. The immersion lithographic apparatus of claim 3, wherein the first surface is lyophilic and the second surface is lyophobic.

7. The immersion lithographic apparatus of claim 1, wherein the pinning features comprise protrusions.

8. The immersion lithographic apparatus of claim 7, wherein at least some of the plurality of protrusions define a plurality of steps.

9. The immersion lithographic apparatus of claim 7, wherein at least some of the plurality of protrusions comprises a plurality of recesses.

10. The immersion lithographic apparatus of claim 7, wherein the protrusions are substantially randomly located along a direction away from an optical axis of the projection system.

11. The immersion lithographic apparatus of claim 7, wherein a surface of each of the protrusions has a displacement of between 1 and 1000 μm from a mean contour, wherein the mean contour is the average displacement of the protrusion relative to a reference surface.

12. The immersion lithographic apparatus of claim 2, wherein the series of pinning features repeats in a direction away from an optical axis of the projection system.

13. The immersion lithographic apparatus of claim 12, wherein a pitch is defined between adjacent pinning features and the pitch is smaller than 5 mm.

14. The immersion lithographic apparatus of claim 1, wherein at least one of the pinning features comprises a fiber.

15. The immersion lithographic apparatus of claim 1, wherein the plurality of pinning features are present substantially around the complete periphery of the part of the lower surface, or the facing surface of the liquid confinement structure, or both.

16. The immersion lithographic apparatus of claim 1, wherein the liquid confinement structure or the projection system comprise a removable component comprising the pinning surface.

17. The immersion lithographic apparatus of claim 16, wherein the removable component is an adhesive sheet.

18. The immersion lithographic apparatus of claim 16, wherein the removable component comprises metal.

19. A method for reducing an evaporational load on a projection system in an immersion lithography apparatus in which a liquid confinement structure is configured to at least partly confine immersion liquid to an immersion space defined by the projection system, the liquid confinement structure and a substrate and/or a substrate table, the method comprising:
pinning a meniscus of the immersion liquid in the immersion space present between a part of a lower surface of the projection system and a facing surface of the liquid confinement structure facing the part of the lower surface using a meniscus pinning feature of a plurality of meniscus pinning features of a pinning surface, the pinning surface being part of or on the part of the lower surface, or of or on the facing surface of the liquid confinement structure, or of or on both.

20. An immersion lithographic apparatus, comprising:
a substrate table configured to hold a substrate;
a projection system configured to project a patterned radiation beam onto a target portion of the substrate, the projection system having a lower surface;
a liquid confinement structure defining, in use, in part with the lower surface and the substrate and/or substrate table, an immersion space, the immersion space comprising, in use, a liquid meniscus between a part of the lower surface facing a surface of the liquid confinement structure and a facing surface of the liquid confinement structure facing the part of the lower surface; and
a pinning surface comprising a plurality of meniscus pinning features, the pinning surface being part of or on the part of the lower surface, or part of or on the facing surface of the liquid confinement structure, or part of or on both, the pinning surface being configured to limit, in use, movement of the meniscus over the lower surface.
